(19) United States
(12) Patent Application Publication
(10) Pub. No.: US 2007/0076672 A1
(43) Pub. Date: Apr. 5, 2007

(54) Method and system for controlling ad-hoc membership in wireless networks to improve battery life

(76) Inventors: Roberto Gautier, Davie, FL (US); Robert A. Marples, Coral Springs, FL (US); Joseph Patino, Pembroke Pines, FL (US); Brian A. Redding, Champaign, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/240,541

(22) Filed: Sep. 30, 2005

(51) Int. Cl. H04Q 7/24

(52) U.S. Cl. 370/338

(57) ABSTRACT

A method (100) and system (10) for controlling ad-hoc membership in wireless networks to improve battery life includes determining (102) the capabilities of each of the members of a network and upon launching an application at a member, determining (104) a profile of members of the network required to support the application. A master device (12) can optionally disassociate (106) from the slave devices surveyed until an application is launched having a profile requiring a particular slave device. The method can further include associating (108) the members of the network in the profile and temporarily disassociating (110) a remaining group of members of the network. At another step (112), the method can also assign a higher priority to the members meeting the profile and assign a lower priority to the members that are temporarily disassociated and thereby reduce a maintenance cycle by probing the lower priority members less frequently.

### FIELD OF THE INVENTION

This invention relates generally to wireless networks, and more particularly to a method and system for improving battery life for members of a wireless network by controlling ad-hoc membership in such wireless network.

### BACKGROUND OF THE INVENTION

On a wireless ad-hoc network, the battery life of the network members is dependent on the member's operational mode, which drives the network service/maintenance interval and response latency of the members. A network master device can link with network members or slave devices and maintain the network links with each of the members by having a frequent “service/maintenance” duty cycle per member causing unnecessary current drain. Once associated with a master device, a slave device cannot always easily disassociate from the network unless it leaves the range of the master device or is turned off. Thus, while the slave device remains within the range of the master device, the slave device “adds” to the service or maintenance duty cycle per member and thus creates greater current drain for all slave devices within the network.

### SUMMARY OF THE INVENTION

Embodiments in accordance with the present invention can modify member's mode of operation in a wireless network “on the fly” to improve battery life depending on the requirements/needs of a network's master. By managing the member association to an ad-hoc network, the active members on the network are the only ones that a user is more likely to use at that point in time. By doing this, the battery life for all network members will be enhanced overall due to lower maintenance duty cycles.

In a first embodiment of the present invention, a method for controlling ad-hoc membership in wireless networks to improve battery life of members of the network can include the steps of determining the capabilities of each of the members of a network (by for example surveying devices within a range of a wireless controller device serving as a master device to determine the capabilities of members serving as slave devices) and upon launching an application at a member, determine a profile of members of the network required to support the application. The method can further optionally disassociate from the slave devices surveyed until an application is launched at one of the slave devices having a profile requiring a particular slave device. The method can further include the steps of associating the members of the network in the profile and temporarily disassociating a remaining group of members of the network. The method can also assign a higher priority to the members meeting the profile and assigning a lower priority to the members that are temporarily disassociated and reduce a maintenance cycle by probing the members having the lower priority less frequently than the members having the higher priority. The method can also determine a sequence in which the remaining group of members can be associated back into in the network in the event of a change in the profile (where the profile can be changed by closing the application, opening a new application, opening a new application while closing the application, and opening the new application while maintaining the application running. The method can also place the slave devices once associated with the network into a sniff mode while waiting for the application to request an actual connection.

In a second embodiment of the present invention, system for controlling ad-hoc membership in a wireless network for improving battery life of at least one member of the network can include a plurality of slave devices, a wireless controller device serving as a master device for managing the ad-hoc membership of each of the slave devices among the plurality slave devices in the wireless network, and a processor coupled to the wireless controller device. The processor can be programmed to determine the capabilities of each of the slave devices, upon launching an application at a slave device, determine a profile of the slave devices of the network required to support the application, associate the slave devices of the network in the profile, and temporarily disassociate a remaining group of slave devices.

In a third embodiment of the present invention, a master device for controlling ad-hoc membership in a wireless network for improving battery life of at least one member of the network can include a transceiver, and a processor coupled to the transceiver. The processor can be programmed to determine the capabilities of each member of the network serving as a slave device to the master device, upon launching an application at a slave device, determine a profile of the slave devices of the network required to support the application, associate the slave devices of the network in the profile, and temporarily disassociate a remaining group of slave devices. The processor can be further programmed to assign a higher priority to the slave devices meeting the profile and assign a lower priority to the slave devices that are temporarily disassociated.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is an illustration of an existing wireless network having a master device and a plurality of slave devices.

FIG. 2 is an illustration of a system utilizing a method for controlling ad-hoc membership to save battery power during a data session in accordance with an embodiment of the present invention.

FIG. 3 is an illustration of a system utilizing a method for controlling ad-hoc membership to save battery power during an audio session in accordance with an embodiment of the present invention.

FIG. 4 is an illustration of a system utilizing a method for controlling ad-hoc membership to save battery power during an audiovisual session in accordance with an embodiment of the present invention.

FIG. 5 is a flow chart illustrating a method for controlling ad-hoc membership to save battery power during a data session in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

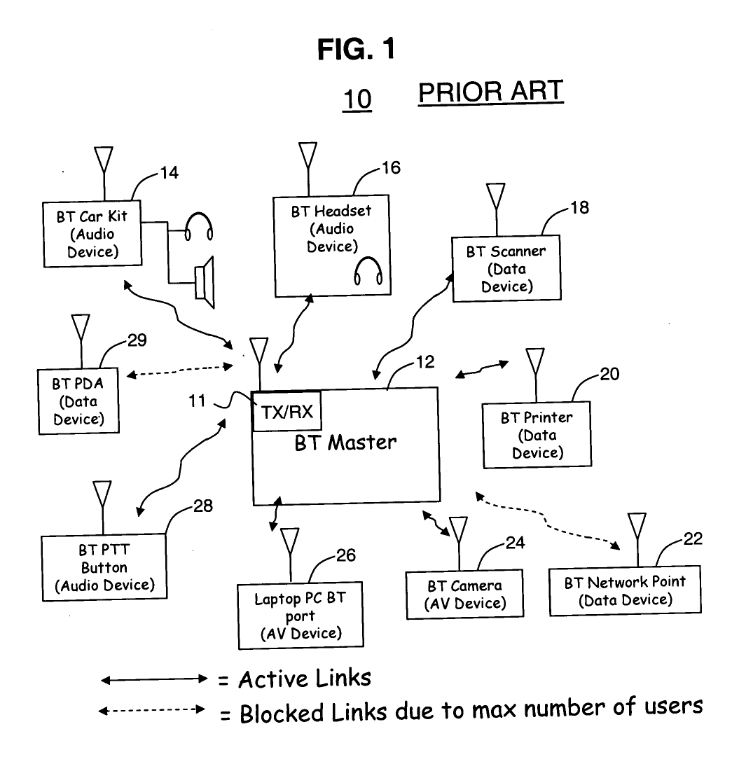

Referring to FIG. 1, an existing wireless network 10 is illustrated such as a Bluetooth piconet having a master device 12 such as a Bluetooth master device in an automobile having a transceiver 11 and a plurality of slave devices 14, 16, 18, 20, 22, 24, 26, 28, and 29 that can include a cellular phone, personal digital assistant, or laptop for example and their various accessories that can be geared toward data, audio or video or audiovisual. In a current mode of operation, the network master 12 will link with the network members or slave devices and will maintain the network links with each of the members. The battery life of each device will be dependant on the “service/maintenance” duty cycle per member. Once associated with the master device 12, a slave device cannot disassociate from the network unless it leaves the range of the master device or is turned off. Thus, while the slave device remains within the range of the master device, the slave device “adds” to the service or maintenance duty cycle per member and thus creates greater current drain for all slave devices within the network. In the context of Bluetooth piconets, a Sniff mode is a low consumption mode where a Bluetooth module would stay synchronized in the piconet. The Bluetooth module would listen to the piconet at regular intervals (Tsniff) for a short instant which would enable it to re-synchronize itself with the piconet and to be able to make use of this Sniff window to send or receive data.

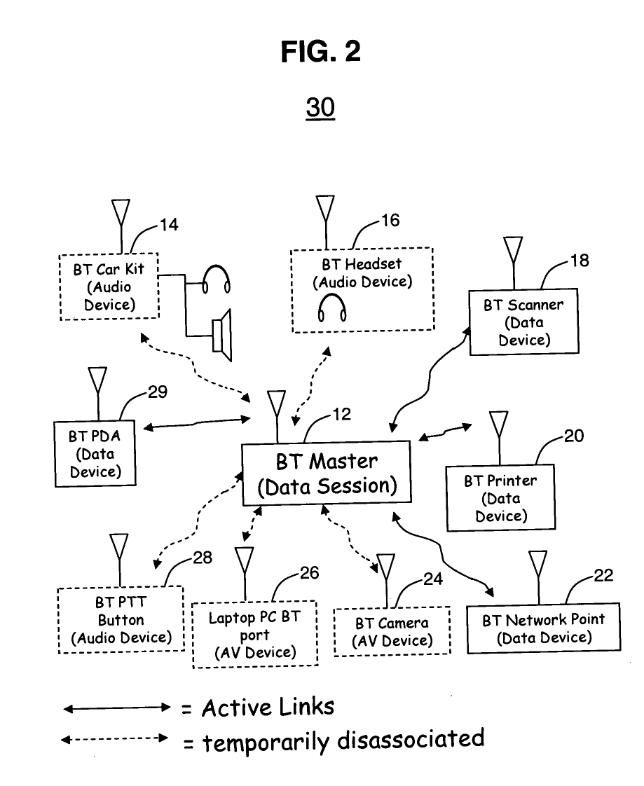

Referring to FIGS. 2-4, a slave device can disassociate from the master device 12 and hence reduce the overall service or maintenance duty cycle per member and reduce current drain for all slave devices within the network. In one embodiment in accordance with the present invention, the master 12 can determine the capabilities of each of the members on the network by surveying all the slave devices 12-29. Once the user enables/disables a specific feature or launches or closes an application on a particular slave device, the master can determine which members are necessary to support the required features or the application. At this point, the master 12 can associate or disassociate members from the network 10. The lower the number of active members, the lower the duty cycle resulting in better battery life.

The disassociated members can be assigned a priority to determine the sequence in which disassociated members can be associated back into the network in case a particular feature or application is re-activated (for example, a headset has higher priority than a Bluetooth Push-to-Talk (PTT) function, if an audio profile is re-activated). By managing the member association to the network 10, the active members on the network 10 are the only ones that the user is more likely to use at that point in time. By doing this, all network member's battery life will be enhanced due to lower maintenance duty cycles.

Referring to FIG. 2, in a data session example where a user enables a data mode application (such as instant messaging), the probability of using network members that support data services is higher than the members supporting audio capabilities. The master 12 can disassociate 5 members (devices 14, 16, 24, 26, and 28) and use the 4 members devices (18, 20, 22, and 29) that support data services. Priorities can then be assigned to the disassociated members or slave devices to be able to bring them back into the network, but a much reduced frequency from the associated members or slave devices. In this manner, there is less activity on the network with only 4 associated slave devices compared to maintaining the whole network with 9 fully associated slave devices, hence lower battery consumption.

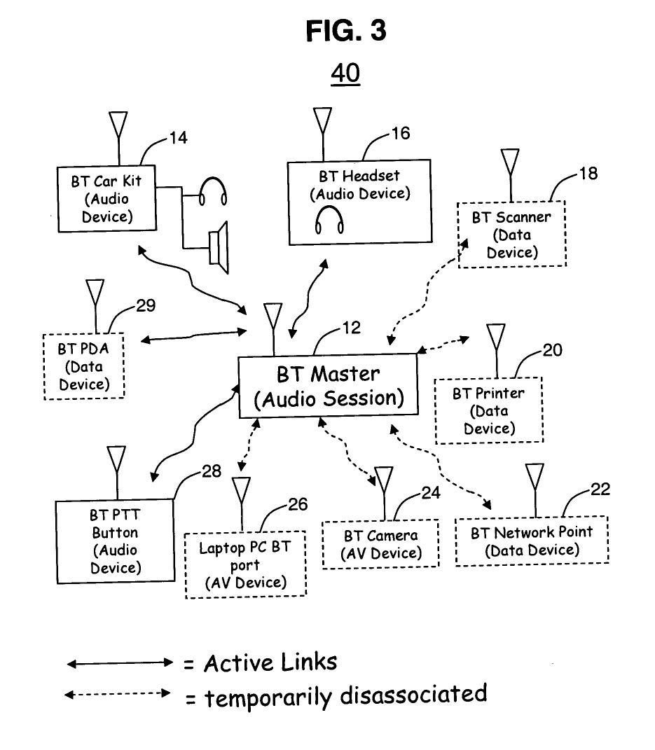

Referring to FIG. 3, in an audio session example where a user finishes with the data session previously described above with respect to FIG. 2, the user can disable the data feature or applications and selects an audio feature or application (such as a cellular voice call or dispatch call connection which is a half-duplex audio call). At this point the members or slave devices supporting data or other unrelated functions (18, 20, 22, 24, 26, and 29) are disassociated and then the members supporting audio (14, 16, and 28) are associated back following the priorities assigned during disassociation. As described above, priorities can then be assigned to the disassociated members to be able to bring them back into the network. In this case, there would be 6 disassociated members and 3 associated members. Once again, this means less activity on the network 10 compared to maintaining the whole network, hence lower battery consumption.

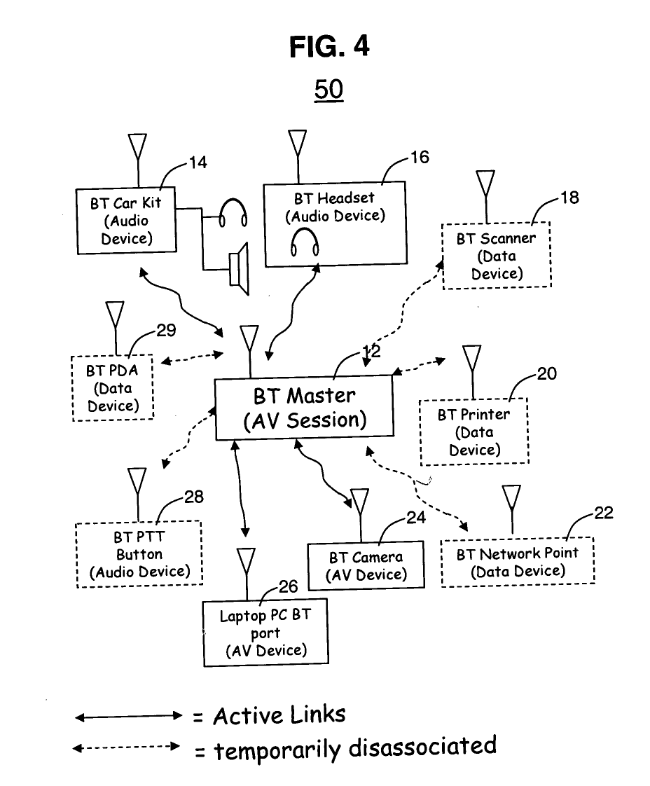

Referring to FIG. 4, if a user is done with a data session as described with respect to FIG. 2 and subsequently disables the feature or application related to the data session and selects an audio visual (AV) feature or application, then the members supporting data will continue being disassociated (18, 20, 22, and 29) and the members supporting audio visual (14, 16, 24, and 26) are associated back following the priorities assigned during disassociation. As described above, priorities are assigned to the newly disassociated members to be able to bring them back into the network. In this case, there are 5 disassociated members (18, 20, 22, 28, and 29) and 4 associated members (14, 16, 24, and 26) which one again means less activity on the network 10 compared to maintaining the whole network and hence lower battery consumption.

On an ad-hock network, members that are not expected to be used (depending on the current master's needs) can be temporarily disassociated from the network. The network controller or master device can determine the capabilities of each of the members on the network. Once the user enables/disables a specific feature or application, the network controller can determine which members are necessary to support the required features. At this point, the master can associate/disassociate members from the network. The lower the number of active members, the lower the duty cycle resulting in better battery life. The disassociated members are assigned a priority to determine the sequence in which disassociated members can be associated back into the network in case the feature is reactivated (for example, the headset has higher priority than the BT PTT, if the audio profile is re-activated).

Disassociating members from the network as described above can extend member's battery life by not needing network servicing/maintenance. Since the members are now temporarily disassociated, the network controller can bring in new members that are more relevant to the current master's state. The new possible member can be either a new member to the network or a member that had been dis-associated. The network controller or master device can also assign a priority to the network members that have been disassociated. This priority can serve as a mechanism to determine the sequence in which members get associated again when the feature is re-enabled.

Note, there are instances where a device attempts to connect to lots of devices to keep in synchronization or to reduce the latency of creating a connection. If such use cases exists, dropping unrelated devices when using profiles exclusive to a smaller set of devices will increase battery savings at the expense of possibly increasing the latency of creating a connection to those devices that have become temporarily disassociated. Further note that although the process of disassociating has been discussed with reference to disabling a function or turning off an application, the scope of the claims should be interpreted to include instances where a function or application is not applicable to a current user activity. For example, if a user was in a multimedia application where the audio visual (AV) devices are associated and the multimedia application is closed, the AV devices are disassociated. In this example the user didn't necessarily actively disable AV, but it was a side effect of the application ending.

In an embodiment with a network where a device does not necessarily automatically connect with lot of devices in the area, a master device can survey all the devices in an area (on a continuous basis) and can connect to these devices temporarily to either assess their capability or to “inform” these devices that this device is in the proximity of the particular device. This allows the master device to know which of the “known” devices and capabilities are in the area and any other device in the area that it could connect to the network without the need for user requested discovery. After the survey the device does not associate with any of the devices.

Upon an application being launched (either in the foreground or background) that can utilize a profile including any number of the surveyed devices, the master device can begin to associate with the slave devices in a priority order (favorites, paired, non-paired) based on availability of active connection slots as in a Bluetooth protocol connection. In cases where authentication is needed with non-paired devices, the association does not need to be made (to reduce the need to enter PINs when the user may not want to connect to that device). Once associated, the devices can go immediately into a sniff mode to reduce power consumption while waiting for the application or the user to request the actual connection. It is possible to connect more than the available active connection slots by parking the lower priority devices since unparking is still faster than reconnecting. Note, the continuous surveying will enable the master device to always know what devices it can connect to in a relatively short amount of time in addition to jumping to alternative devices (say headset instead of car kit) if the highest priority device was not present in the last survey. This arrangement allows the audio transfer to happen much faster since the device doesn't need to try to page the car kit and can go directly to paging the headset. Thus, the triggering event for creating associations can be the applications that a user explicitly runs or that are implicitly run in the background by the master device such as a cell phone in this instance.

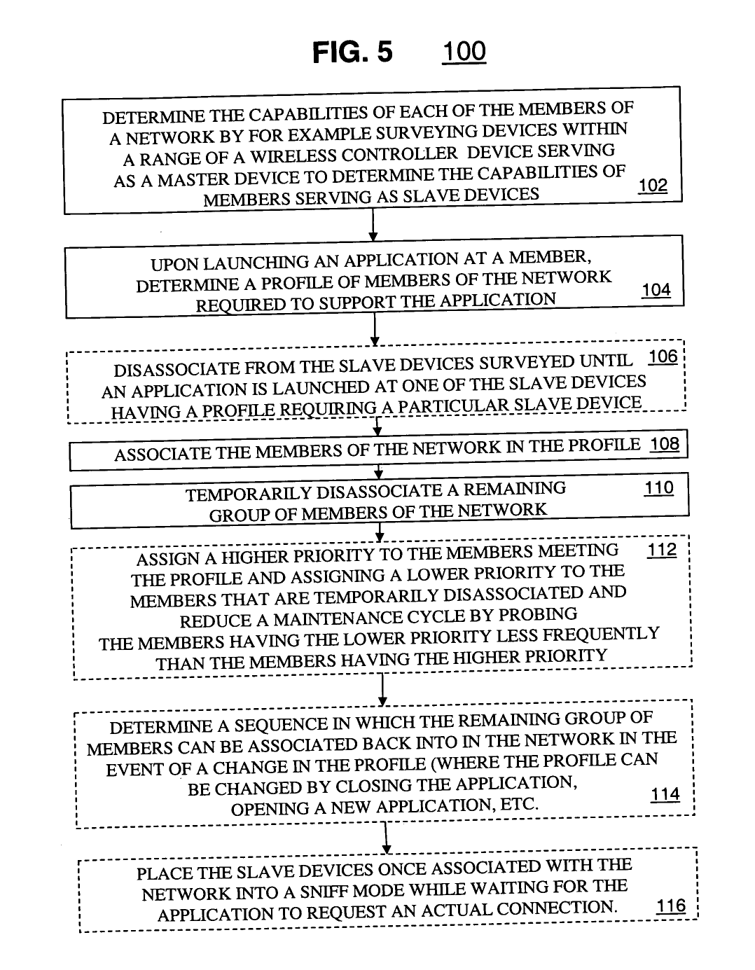

Referring to FIG. 5, a flow chart of a method 100 for controlling ad-hoc membership in wireless networks to improve battery life of members of the network is shown. The method 100 can include the step 102 of determining the capabilities of each of the members of a network (by for example surveying devices within a range of a wireless controller device serving as a master device to determine the capabilities of members serving as slave devices) and upon launching an application at a member at step 104, determine a profile of members of the network required to support the application. The method 100 can further optionally disassociate from the slave devices surveyed at step 106 until an application is launched at one of the slave devices having a profile requiring a particular slave device. The method 100 can further include the step 108 of associating the members of the network in the profile and the step 110 of temporarily disassociating a remaining group of members of the network. The method 100 can also assign a higher priority to the members meeting the profile and assigning a lower priority to the members that are temporarily disassociated and reduce a maintenance cycle by probing the members having the lower priority less frequently than the members having the higher priority at step 112. The method 100 can also determine at step 114 a sequence in which the remaining group of members can be associated back into in the network in the event of a change in the profile (where the profile can be changed by closing the application, opening a new application, opening a new application while closing the application, and opening the new application while maintaining the application running. The method 100 can also at step 116 place the slave devices once associated with the network into a sniff mode while waiting for the application to request an actual connection.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein. Further note that although a few particular short-range devices such as Bluetooth devices were discussed, embodiments are not necessarily limited thereto. For example, a master device may have several primary use cases: scanning/printing, streaming video, or file transfer/printing. Scanning/printing devices can be barcode scanners, receipt printers, or database/invoice systems. A streaming video device can include video cameras and data connections. A file transfer/printing device can include computers, cameras, or photo printers. When the master device is performing scanning/printing, embodiments in accordance with the invention can deactivate some major functions even where the device types may overlap based on the current solution being provided by the device. Thus, embodiments can be formed or grouped by solution set as well as simply by device type and no limitation is intended by the examples provided.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method for controlling ad-hoc membership in wireless networks to improve battery life of members of the network, comprising the steps of:
determining the capabilities of each of the members of a network;
upon launching an application at a member, determining a profile of members of the network required to support the application;
associate the members of the network in the profile; and
temporarily disassociate a remaining group of members of the network.

2. The method of claim 1, wherein the method further comprises the step of assigning a higher priority to the members meeting the profile and assigning a lower priority to the members that are temporarily disassociated.

3. The method of claim 1, wherein the method further comprises the step of assigning a lower priority to the remaining group of members to determine a sequence in which the remaining group of members can be associated back into in the network in the event of a change in the profile.

4. The method of claim 3, wherein the method comprises the step of changing the profile by performing at least one among closing the application, opening a new application while closing the application, and opening the new application while maintaining the application running.

5. The method of claim 1, wherein the method further comprises the step of reducing a maintenance cycle by probing the members having the lower priority less frequently than the members having the higher priority.

6. The method of claim 1, wherein the step of determining the capabilities comprises surveying devices within a range of a wireless controller device serving as a master device to determine the capabilities of members serving as slave devices.

7. The method of claim 6, wherein the method further comprises the step of disassociating from the slave devices surveyed until an application is launched at one of the slave devices having a profile requiring a particular slave device.

8. The method of claim 6, wherein the method further comprises the step of placing the slave devices once associated with the network into a sniff mode while waiting for the application to request an actual connection.

9. The method of claim 6, wherein the method further comprises the step of continuously surveying devices within the range of the master device.

10. A system for controlling ad-hoc membership in a wireless network for improving battery life of at least one member of the network, comprising:
a plurality of slave devices;
a wireless controller device serving as a master device for managing the ad-hoc membership of each of the slave devices among the plurality slave devices in the wireless network; and
a processor coupled to the wireless controller device, wherein the processor is programmed to:
determine the capabilities of each of the slave devices;
upon launching an application at a slave device, determine a profile of the slave devices of the network required to support the application;
associate the slave devices of the network in the profile; and
temporarily disassociate a remaining group of slave devices.

11. The system of claim 10, wherein the processor is further programmed to assign a higher priority to the slave devices meeting the profile and assign a lower priority to the slave devices that are temporarily disassociated.

12. The system of claim 10, wherein the processor is further programmed to assign a lower priority to the remaining group of slave devices to determine a sequence in which the remaining group of slave devices can be associated back into in the network in the event of a change in the profile.

13. The system of claim 12, wherein the profile is changed by performing at least one among closing the application, opening a new application while closing the application, and opening the new application while maintaining the application running.

14. The system of claim 10, wherein the processor is further programmed to reduce a maintenance cycle by probing the slave devices having the lower priority less frequently than the slave devices having the higher priority.

15. The system of claim 10, wherein the processor is further programmed to disassociate from the slave devices surveyed until an application is launched at one of the slave devices having a profile requiring a particular slave device.

16. The system of claim 10, wherein the processor is further programmed to place the slave devices once associated with the network into a sniff mode while waiting for the application to request an actual connection.

17. The system of claim 10, wherein the processor is further programmed to continuously survey slave devices within the range of the master device.

18. The system of claim 10, wherein the master device is a Bluetooth master device and the plurality of slave devices is selected among the group of Bluetooth audio devices, Bluetooth data devices, and Bluetooth audiovisual devices.

19. A master device for controlling ad-hoc membership in a wireless network for improving battery life of at least one member of the network, comprising:
a transceiver;
a processor coupled to the transceiver, wherein the processor is programmed to:
determine the capabilities of each member of the network serving as a slave device to the master device;
upon launching an application at a slave device, determine a profile of the slave devices of the network required to support the application;
associate the slave devices of the network in the profile; and
temporarily disassociate a remaining group of slave devices.

20. The master device of claim 19, wherein the processor is further programmed to assign a higher priority to the slave devices meeting the profile and assign a lower priority to the slave devices that are temporarily disassociated.
